(19) United States
(12) Patent Application Publication
(10) Pub. No.: US 2025/0059062 A1
(43) Pub. Date: Feb. 20, 2025

(54) METHOD FOR PREPARING HIGH-PERFORMANCE COMPOSITE FERRITE FOR SELF-BIASED CIRCULATOR

(71) Applicant: China Jiliang University, Hangzhou (CN)

(72) Inventors: Minxiang PAN, Hangzhou (CN); Hangfu YANG, Hangzhou (CN); Nengjun YU, Hangzhou (CN); Qiong WU, Hangzhou (CN); Hongliang GE, Hangzhou (CN)

(73) Assignee: China Jiliang University, Hangzhou (CN)

(21) Appl. No.: 18/740,565

(22) Filed: Jun. 12, 2024

(30) Foreign Application Priority Data
Aug. 15, 2023 (CN) 202311020957.8

(51) Int. Cl. C01G 49/00; H01F 1/10

(52) U.S. Cl. CPC C01G 49/0063; H01F 1/10; C01P 2006/42

(57) ABSTRACT

A magnetic material and method prepares high-performance composite ferrite for a self-biased circulator. The preparation method includes: (1) preparing BaM ferrite initial powder and NiCuZnSn ferrite initial powder, respectively; (2) mixing the BaM ferrite initial powder, the NiCuZnSn ferrite initial powder and deionized water uniformly in proportion, performing ball milling in a high-energy ball mill, and then obtaining mixed powder after primary pre-sintering, secondary pre-sintering and secondary ball milling; and (3) obtaining the high-performance composite ferrite for the self-biased circulator by a low-temperature magnetic field orientation forming technology and magnetic field heat treatment. According to the present invention, the saturated magnetization intensity is enhanced better by compounding the BaM ferrite powder and the NiCuZnSn ferrite powder and through a high-energy ball milling technology, the low-temperature magnetic field orientation forming technology and the magnetic field heat treatment technology, thereby improving the microstructure and the magnetic characteristic of bi-phase composite ferrite.

### CROSS REFERENCE TO RELATED APPLICATION

This application is based upon and claims foreign priority to Chinese Patent Application No. CN202311020957.8, filed on Aug. 15, 2023, the entire content of which is incorporated herein by reference.

### TECHNICAL FIELD

The present invention relates to the technical field of a magnetic material, and in particular to a method for preparing high-performance composite ferrite for a self-biased circulator.

### BACKGROUND

With the wide application of active phased array radars in modern electronic countermeasures, microwave devices with high frequency, small size and low loss have become the research focus microwave and millimeter wave technologies. A microwave circulator is an indispensable important component in a transmit/receive (T/R) assembly, a large permanent magnet is required to be arranged in the traditional circulator to provide a direct current bias field, so that it is difficult for a transmit-receive system to realize the minimization of a complete machine. Uniaxial hexagonal ferrite has the characteristics of large magnetocrystalline anisotropy and high magnetization intensity. The microwave circulator prepared based on the design of the uniaxial hexagonal ferrite has a self-biased field and does not require a permanent magnet, which has a great significance in realizing the miniaturization and planarization of the microwave circulator and even the T/R assembly.

A gyromagnetic material is widely used in the field of microwave, but with the improvement of microwave devices and application technology, the requirements on the gyromagnetic material are higher and higher, so it is extremely urgent to further improve the performance of the gyromagnetic material, particularly a material with high broadband temperature stability and low loss. According to the present invention, by creatively compounding the BaM ferrite powder and the NiCuZnSn ferrite powder and through a high-energy ball milling technology, the grain boundary characteristic is effectively regulated and controlled, the orientation degree is increased, the saturated magnetization intensity is enhanced, and the microstructure and the magnetic characteristic of bi-phase composite ferrite is improved with the addition of other elements.

### SUMMARY

In view of the problems in the prior art, an objective of the present invention is to provide a method for preparing high-performance composite ferrite for a self-biased circulator.

The method for preparing high-performance composite ferrite for the self-biased circulator provided by the present invention includes the following steps:
(1) preparing BaM ferrite initial powder: taking BaCO₃, La₂O₃ and Fe₂O₃ as raw materials, and weighing and mixing the materials according to the proportion of 5-15 mol % of BaCO₃, 2-12 mol % of La₂O₃ and 73-93 mol % of Fe₂O₃ to obtain the BaM ferrite initial powder;
(2) preparing NiCuZnSn ferrite initial powder: taking NiO, ZnO, CuO, SnO2, Co₂O₃ and Fe₂O₃ as raw materials, and weighing and mixing the materials according to the proportion of 20-40 mol % of NiO, 5-30 mol % of ZnO, 2-10 mol % of CuO, 1-5 mol % of SnO₂, 4-10 mol % of Co₂O₃ and 5-68 mol % of Fe₂O₃ to obtain the NiCuZnSn ferrite initial powder;
(3) uniformly mixing the BaM ferrite initial powder obtained in step (1), the NiCuZnSn ferrite initial powder obtained in step (2) and deionized water according to a mass ratio of 1: (0.1-1): (3-5) to obtain mixed powder slurry, and then uniformly mixing the mixed powder slurry in a high-energy ball mill, where the high-energy ball-milling time is 1-3 h;
(4) drying ball-milled powder obtained in step (3), sieving, and then performing primary pre-sintering and secondary pre-sintering on the powder to obtain mixed powder;
(5) uniformly mixing the mixed powder obtained in step (4) and deionized water according to a mass ratio of 1: (3-5), and performing secondary high-energy ball milling to obtain powder slurry, wherein the high-energy ball-milling time is 0.5-1.5 h;
(6) preparing a green compact from the powder slurry obtained in step (5) by a low-temperature magnetic field orientation forming technology, wherein in the low-temperature magnetic field orientation forming technology, the temperature is 50-150° C., the pressure is 40-150 MPa, and the magnetic field intensity is 2-4 T; and
(7) performing magnetic field heat treatment on the green compact obtained in step (6) to finally obtain the high-performance composite ferrite for the self-biased circulator.

Further, in step (4), in the primary pre-sintering, the sintering temperature is 1050-1350° C., the heating rate is 1-3° C./min and the heat preservation time is 2-7 h, and in the secondary pre-sintering, the sintering temperature is 800-1000° C., the heating rate is 1-3° C./min and the heat preservation time is 1-4 h.

Further, in the magnetic field heat treatment described in step (7), the magnetic field intensity is 1-2 T, the heat treatment temperature is 800-1100° C., the heating rate is 1-3° C./min, the heat preservation time is 2-6 h, and then emergency cooling is performed to room temperature.

Compared with the prior art, the present invention has the following advantages and beneficial effects: according to the present invention, by creatively compounding the BaM ferrite powder and the NiCuZnSn ferrite powder and through a high-energy ball milling technology, the grain boundary characteristic is effectively regulated and controlled, the orientation degree is increased, the saturated magnetization intensity is enhanced, and the microstructure and the magnetic characteristic of bi-phase composite ferrite is improved with the addition of other elements.

### DETAILED DESCRIPTION OF THE EMBODIMENTS

The present invention is further described in detail below with reference to embodiments, but the present invention is not limited to the following embodiments.

### Embodiment 1

(1) Preparation of BaM ferrite initial powder: BaCO₃, La₂O₃ and Fe₂O₃ were taken as raw materials, and the materials were weighed and mixed according to the proportion of 5 mol % of BaCO₃, 10 mol % of La and 85 mol % of Fe to obtain the BaM ferrite initial powder.
(2) Preparation of NiCuZnSn ferrite initial powder: NiO, ZnO, CuO, SnO2, Co2O3 and Fe₂O₃ were taken as raw materials, and the materials were weighed and mixed according to the proportion of 20 mol % of NiO, 5 mol % of ZnO, 2 mol % of CuO, 1 mol % of SnO₂, 4 mol % of Co₂O₃ and 68 mol % of Fe₂O₃ to obtain the NiCuZnSn ferrite initial powder.
(3) The BaM ferrite initial powder obtained in step (1), the NiCuZnSn ferrite initial powder obtained in step (2) and deionized water were uniformly mixed according to a mass ratio of 1:0.3:3 to obtain mixed powder slurry, and then the mixed powder slurry was mixed uniformly in a high-energy ball mill, where the high-energy ball-milling time is 1 h.
(4) The ball-milled powder obtained in step (3) was dried and sieved, and then primary pre-sintering and secondary pre-sintering were performed on the powder to obtain mixed powder, where in the primary pre-sintering, the sintering temperature is 1050° C., the heating rate is 1° C./min and the heat preservation time is 6 h, and in the secondary pre-sintering, the sintering temperature is 1000° C., the heating rate is 3° C./min and the heat preservation time is 1 h.
(5) The mixed powder obtained in step (4) and deionized water were mixed uniformly according to a mass ratio of 1:3, and secondary high-energy ball milling was performed to obtain powder slurry, where the high-energy ball-milling time is 0.5 h.
(6) A green compact was prepared from the powder slurry obtained in step (5) by a low-temperature magnetic field orientation forming technology, where in the low-temperature magnetic field orientation forming technology, the temperature is 50° C., the pressure is 150 MPa, and the magnetic field intensity is 2 T.
(7) Magnetic field heat treatment was performed on the green compact obtained in step (6) under the conditions of the magnetic field intensity being 1 T, the heat treatment temperature being 1000°° C., the heating temperature being 3° C./min and the heat preservation time being 6 h, and then emergency cooling was performed to room temperature to finally obtain the composite ferrite.

After the composite ferrite prepared by the present invention is tested by a magnetic performance and vector network analyzer, the saturated magnetization intensity 4πMₛ is 4850 Gs, the remanence ratio Mᵣ/Mₛ is 0.89, the coercive force H_{c} is 4010 Oe, the ferromagnetic resonance linewidth ΔH is 368 Oe, and the anisotropy field Hₐ is 14.10 kOe.

### Embodiment 2

(1) Preparation of BaM ferrite initial powder: BaCO₃, La₂O₃ and Fe₂O₃ were taken as raw materials, and the materials were weighed and mixed according to the proportion of 10 mol % of BaCO₃, 8 mol % of La₂O₃ and 82 mol % of Fe₂O₃ to obtain the BaM ferrite initial powder.
(2) Preparation of NiCuZnSn ferrite initial powder: NiO, ZnO, CuO, SnO₂, Co₂O₃ and Fe₂O₃ were taken as raw materials, and the materials were weighed and mixed according to the proportion of 30 mol % of NiO, 15 mol % of ZnO, 5 mol % of CuO, 3 mol % of SnO₂, 7 mol % of C₂O₃ and 40 mol % of Fe₂O₃ to obtain the NiCuZnSn ferrite initial powder.
(3) The BaM ferrite initial powder obtained in step (1), the NiCuZnSn ferrite initial powder obtained in step (2) and deionized water were uniformly mixed according to a mass ratio of 1:0.5:4 to obtain mixed powder slurry, and then the mixed powder slurry was mixed uniformly in a high-energy ball mill, where the high-energy ball-milling time is 2 h.
(4) The ball-milled powder obtained in step (3) was dried and sieved, and then primary pre-sintering and secondary pre-sintering were performed on the powder to obtain mixed powder, where in the primary pre-sintering, the sintering temperature is 1150° C., the heating rate is 2° C./min and the heat preservation time is 4 h, and in the secondary pre-sintering, the sintering temperature is 900° C., the heating rate is 2° C./min and the heat preservation time is 2 h.
(5) The mixed powder obtained in step (4) and deionized water were mixed uniformly according to a mass ratio of 1:4, and secondary high-energy ball milling was performed to obtain powder slurry, where the high-energy ball-milling time is 1 h.
(6) A green compact was prepared from the powder slurry obtained in step (5) by a low-temperature magnetic field orientation forming technology, where in the low-temperature magnetic field orientation forming technology, the temperature is 100° C., the pressure is 100 MPa, and the magnetic field intensity is 3 T.
(7) Magnetic field heat treatment was performed on the green compact obtained in step (6) under the conditions of the magnetic field intensity being 1.5 T, the heat treatment temperature being 900° C., the heating temperature being 2° C./min and the heat preservation time being 4 h, and then emergency cooling was performed to room temperature to finally obtain the composite ferrite.

After the composite ferrite prepared by the present invention is tested by a magnetic performance and vector network analyzer, the saturated magnetization intensity 4πMs is 4910 Gs, the remanence ratio Mᵣ/Mₛ is 0.90, the coercive force H_{c} is 4100 Oe, the ferromagnetic resonance linewidth ΔH is 350 Oe, and the anisotropy field Hₐ is 13.93 kOe.

### Embodiment 3

(1) Preparation of BaM ferrite initial powder: BaCO₃, La₂O₃ and Fe₂O₃ were taken as raw materials, and the materials were weighed and mixed according to the proportion of 15 mol % of BaCO₃, 5 mol % of La₂O₃ and 80 mol % of Fe₂O₃ to obtain the BaM ferrite initial powder.
(2) Preparation of NiCuZnSn ferrite initial powder: NiO, ZnO, CuO, SnO₂, Co₂O₃ and Fe₂O₃ were taken as raw materials, and the materials were weighed and mixed according to the proportion of 40 mol % of NiO, 25 mol % of ZnO, 8 mol % of CuO, 5 mol % of SnO₂, 9 mol % of Co₂O₃ and 13 mol % of Fe₂O₃ to obtain the NiCuZnSn ferrite initial powder.
(3) The BaM ferrite initial powder obtained in step (1), the NiCuZnSn ferrite initial powder obtained in step (2) and deionized water were uniformly mixed according to a mass ratio of 1:1:5 to obtain mixed powder slurry, and then the mixed powder slurry was mixed uniformly in a high-energy ball mill, where the high-energy ball-milling time is 3 h.
(4) The ball-milled powder obtained in step (3) was dried and sieved, and then primary pre-sintering and secondary pre-sintering were performed on the powder to obtain mixed powder, where in the primary pre-sintering, the sintering temperature is 1350° C., the heating rate is 3° C./min and the heat preservation time is 2 h, and in the secondary pre-sintering, the sintering temperature is 800°° C., the heating rate is 1° C./min and the heat preservation time is 4 h.
(5) The mixed powder obtained in step (4) and deionized water were mixed uniformly according to a mass ratio of 1:5, and secondary high-energy ball milling was performed to obtain powder slurry, where the high-energy ball-milling time is 1.5 h.
(6) A green compact was prepared from the powder slurry obtained in step (5) by a low-temperature magnetic field orientation forming technology where in the low-temperature magnetic field orientation forming technology, the temperature is 150° C., the pressure is 60 MPa, and the magnetic field intensity is 4 T.
(7) Magnetic field heat treatment was performed on the green compact obtained in step (6) under the conditions of the magnetic field intensity being 2 T, the heat treatment temperature being 800° C., the heating temperature being 1° C./min and the heat preservation time being 2 h, and then emergency cooling was performed to room temperature to finally obtain the composite ferrite.

After the composite ferrite prepared by the present invention is tested by a magnetic performance and vector network analyzer, the saturated magnetization intensity 4πMₛ is 4978 Gs, the remanence ratio Mᵣ/Mₛ is 0.91, the coercive force H_{c} is 4250 Oe, the ferromagnetic resonance linewidth ΔH is 340 Oe, and the anisotropy field Hₐ is 13.55 kOe.

What is claimed is:

1. A method for preparing high-performance composite ferrite for a self-biased circulator, comprising:
(1) preparing BaM ferrite initial powder: taking BaCO₃, La₂O₃ and Fe₂O₃ as raw materials, and weighing and mixing the materials according to the proportion of 5-15 mol % of BaCO3, 2-12 mol % of La₂O₃ and 73-93 mol % of Fe₂O₃ to obtain the BaM ferrite initial powder;
(2) preparing NiCuZnSn ferrite initial powder: taking NiO, ZnO, CuO, SnO₂, Co₂O₃ and Fe₂O₃ as raw materials, and weighing and mixing the materials according to the proportion of 20-40 mol % of NiO, 5-30 mol % of ZnO, 2-10 mol % of CuO, 1-5 mol % of SnO2, 4-10 mol % of Co₂O₃ and 40-68 mol % of Fe₂O₃ to obtain the NiCuZnSn ferrite initial powder;
(3) uniformly mixing the BaM ferrite initial powder obtained in step (1), the NiCuZnSn ferrite initial powder obtained in step (2) and deionized water according to a mass ratio of 1: (0.1-1): (3-5) to obtain mixed powder slurry, and then uniformly mixing the mixed powder slurry in a high-energy ball mill, wherein the high-energy ball-milling time is 1-3 hours;
(4) drying ball-milled powder obtained in step (3), sieving, and then performing primary pre-sintering and secondary pre-sintering on the powder to obtain mixed powder, wherein in the primary pre-sintering, the sintering temperature is 1050-1350° C., the heating rate is 1-3° C./min and the heat preservation time is 2-7 hours, and in the secondary pre-sintering, the sintering temperature is 800-1000° C., the heating rate is 1-3° C./min and the heat preservation time is 1-4 hours;
(5) uniformly mixing the mixed powder obtained in step (4) and deionized water according to a mass ratio of 1: (3-5), and performing secondary high-energy ball milling to obtain powder slurry, wherein the high-energy ball-milling time is 0.5-1.5 hours;
(6) preparing a green compact from the powder slurry obtained in step (5) by a low-temperature magnetic field orientation forming technology, wherein in the low-temperature magnetic field orientation forming technology, the temperature is 50-150°° C., the pressure is 40- 150 MPa, and the magnetic field intensity is 2-4 T; and
(7) performing magnetic field heat treatment on the green compact obtained in step (6) to finally obtain the high-performance composite ferrite for the self-biased circulator.

2. The method for preparing high-performance composite ferrite for a self-biased circulator according to claim 1, wherein in the magnetic field heat treatment described in step (7), the magnetic field intensity is 1-2 T, the heat treatment temperature is 800-1100° C., the heating rate is 1-3° C./min, the heat preservation time is 2-6 hours, and then emergency cooling is performed to room temperature.
